(19) United States
(12) Patent Application Publication
(10) Pub. No.: US 2025/0345738 A1
(43) Pub. Date: Nov. 13, 2025

(54) SYSTEM AND METHOD FOR GAS TREATMENT VIA MOVABLE ADSORPTION MODULE

(71) Applicant: GENERAL ELECTRIC TECHNOLOGY GMBH, Baden (CH)

(72) Inventors: Parag P. KULKARNI, Schenectady, NY (US); Majed SAMMAK, Dammam, Eastern Region (SA)

(21) Appl. No.: 18/867,483

(22) PCT Filed: May 25, 2022
(86) PCT No.: PCT/US2022/030967

§ 371 Date: Nov. 20, 2024

(51) Int. Cl. B01D 53/04

(52) U.S. Cl. CPC B01D 53/0415; B01D 53/0454; B01D 2257/504; B01D 2258/01

(57) ABSTRACT

A system includes a gas treatment system having an adsorption module, wherein the adsorption module includes one or more sorbent cartridges having a sorbent material. The gas treatment system further includes a linear positioning assembly configured to move the adsorption module along a linear path of travel between a first position in a first flow path and a second position in a second flow path. The gas treatment system is configured to adsorb an undesirable gas from a first fluid flow in the first flow path into the sorbent material when the adsorption module is disposed in the first position. The gas treatment system is configured to desorb the undesirable gas from the sorbent material when the adsorption module is disposed in the second position.

### BACKGROUND

The present application relates generally to a system and method for treating a gas, such as a gas fuel or an exhaust gas.

An industrial plant, such as a power plant, may consume or produce a variety of gases, such as a fuel gas (e.g., natural gas or synthesis gas) and/or an exhaust gas of a combustion system. The combustion system may include a gas turbine engine, a reciprocating piston-cylinder engine, a furnace, a boiler, or other industrial equipment. These gases may include one or more undesirable gases, such as acid gases and/or exhaust emissions gases. For example, the undesirable gases may include hydrogen sulfide (H₂S), carbon oxides such as carbon dioxide (CO₂), nitrogen oxides such as nitrogen dioxide (NO₂), and/or sulfur oxides such as sulfur dioxide (SO₂). Accordingly, it may be desirable to treat certain gases to remove the undesirable gases from a gas flow, such as by removing the undesirable gases from the fuel gas upstream of the combustion system and/or removing the undesirable gases from the exhaust gas discharged by the combustion system. A gas treatment system may include a solvent-based absorption system configured to absorb the undesirable gases into a solvent, which subsequently flows through a solvent regeneration system to remove the undesirable gases. However, the solvent-based absorption system generally includes a variety of equipment external to a duct (e.g., fuel supply duct or exhaust duct) carrying the gas flow, and thus can increase the costs, complexity, and footprint of the solvent-based absorption system. Accordingly, a need exists for a gas treatment system that can operate continuously without relying on a solvent-based absorption system.

### BRIEF DESCRIPTION

Certain embodiments commensurate in scope with the originally claimed subject matter are summarized below. These embodiments are not intended to limit the scope of the claimed embodiments, but rather these embodiments are intended only to provide a brief summary of possible forms of the subject matter. Indeed, the presently claimed embodiments may encompass a variety of forms that may be similar to or different from the embodiments set forth below.

In certain embodiments, a system includes a gas treatment system having an adsorption module, wherein the adsorption module includes one or more sorbent cartridges having a sorbent material. The gas treatment system further includes a linear positioning assembly configured to move the adsorption module along a linear path of travel between a first position in a first flow path and a second position in a second flow path. The gas treatment system is configured to adsorb an undesirable gas from a first fluid flow in the first flow path into the sorbent material when the adsorption module is disposed in the first position. The gas treatment system is configured to desorb the undesirable gas from the sorbent material when the adsorption module is disposed in the second position.

In certain embodiments, a system includes a first duct having a first flow path, a second duct having a second flow path, and a plurality of adsorption modules, wherein each adsorption module of the plurality of adsorption modules includes one or more sorbent cartridges having a sorbent material. The system further includes a plurality of linear positioning assemblies, wherein each linear positioning assembly of the plurality of linear positioning assemblies is configured to independently move one of the plurality of adsorption modules between the first and second ducts.

In certain embodiments, a method includes moving, via a linear positioning assembly, an adsorption module of a gas treatment system along a linear path of travel between a first position in a first flow path and a second position in a second flow path, wherein the adsorption module includes one or more sorbent cartridges having a sorbent material. The method further includes adsorbing an undesirable gas into the sorbent material of the adsorption module when the adsorption module is disposed in the first position in the first flow path. The method further includes desorbing the undesirable gas from the sorbent material of the adsorption module when the adsorption module is disposed in the second position in the second flow path.

### BRIEF DESCRIPTION OF THE DRAWINGS

These and other features, aspects, and advantages of the presently disclosed techniques will become better understood when the following detailed description is read with reference to the accompanying drawings in which like characters represent like parts throughout the drawings, wherein:

FIG. 1 is a schematic of an embodiment of a gas turbine system having a gas treatment system having one or more adsorption modules configured to remove an undesirable gas.

FIG. 2 is a schematic of an embodiment of the gas treatment system of FIG. 1, further illustrating an adsorption system having a plurality of moveable adsorption assemblies, each having an adsorption module that moves linearly between first and second ducts via a linear positioning assembly.

FIG. 3 is a schematic of an embodiment of a temperature control system having heat exchangers configured to providing heating and/or cooling for the gas treatment system of FIGS. 1 and 2.

FIG. 4 is a schematic of an embodiment of a direct heat exchange system having a fluid distribution manifold with a plurality of nozzles configured to inject a fluid for direct heat transfer in the gas treatment system of FIGS. 1 and 2.

FIG. 5 is a perspective view of an embodiment of the adsorption module of FIGS. 1 and 2, further illustrating a sorbent cartridge disposed in a framework of the adsorption module.

FIG. 6 is a perspective view of an embodiment of the adsorption module of FIGS. 1 and 2, further illustrating a plurality of sorbent cartridges disposed in respective cartridge openings in the framework of the adsorption module, wherein each of the plurality of sorbent cartridges is independently removable for servicing and replacement.

FIG. 7 is a partial schematic view of an embodiment of the moveable adsorption assembly of FIG. 2, further illustrating details of the linear positioning assembly having slides disposed in rails of respective rail assemblies.

FIG. 8 is a partial cross-sectional view of an embodiment of the rail assembly coupled to the adsorption module, further illustrating details of one of the slides disposed in a respective rail.

FIG. 9 is a schematic view of an embodiment of the moveable adsorption assembly of FIG. 2, further illustrating details of a seal disposed about an opening in an intermediate wall between the first and second ducts.

FIG. 10 is a partial cross-sectional view of an embodiment of the moveable adsorption assembly taken along line 10-10 of FIG. 9, further illustrating details of the seal having fibers of a brush seal disposed against the adsorption module.

FIG. 11 is a schematic view of an embodiment of the moveable adsorption assembly of FIG. 2, further illustrating details of an access panel disposed over an access opening in the first duct to enable insertion and removal of the adsorption module.

FIG. 12 is a partial perspective view of an embodiment of the gas treatment system of FIG. 2, further illustrating details of the adsorption module partially removed from the first duct via the access opening.

FIG. 13 is a partial cross-sectional view of an embodiment of the access panel coupled to the first duct of FIGS. 2, 11, and 12.

FIG. 14 is a flow chart of an embodiment of a process for treating gas via a moveable adsorption assembly having an adsorption module that moves between first and second ducts to perform adsorption and desorption, respectively.

### DETAILED DESCRIPTION

One or more specific embodiments of the presently disclosed systems are described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the presently disclosed embodiments, the articles “a,” “an,” “the,” and “said” are intended to mean that there are one or more of the elements. The terms “comprising,” “including,” and “having” are intended to be inclusive and mean that there may be additional elements other than the listed elements.

The disclosed embodiments include gas treatment systems and methods to enable gas treatment using a plurality of adsorption modules, which are configured to move back and forth between a first duct to perform adsorption of undesirable gases and a second duct to perform desorption of the undesirable gases. The first and second ducts may be disposed adjacent and along one another, such that the adsorption modules can move directly between and inside of the first and second ducts. The adsorption modules may be configured to move linearly between the ducts along rail assemblies, which may be oriented crosswise (e.g., perpendicular) to longitudinal axes of the first and second ducts. The adsorption modules may include one or more removable sorbent cartridges, which can be removed and replaced independently from one another. The adsorption modules also may be accessible via access panels in the first duct and/or the second duct to perform inspections, servicing, replacements, or other maintenance procedures. The adsorption modules also may be moved back and forth between the first and second ducts in a staggered manner, such that one or more adsorption modules are adsorbing the undesirable gases in the first duct while one or more adsorption modules are desorbing the undesirable gases in the second duct. Various aspects and embodiments of the gas treatment system are discussed in further detail below.

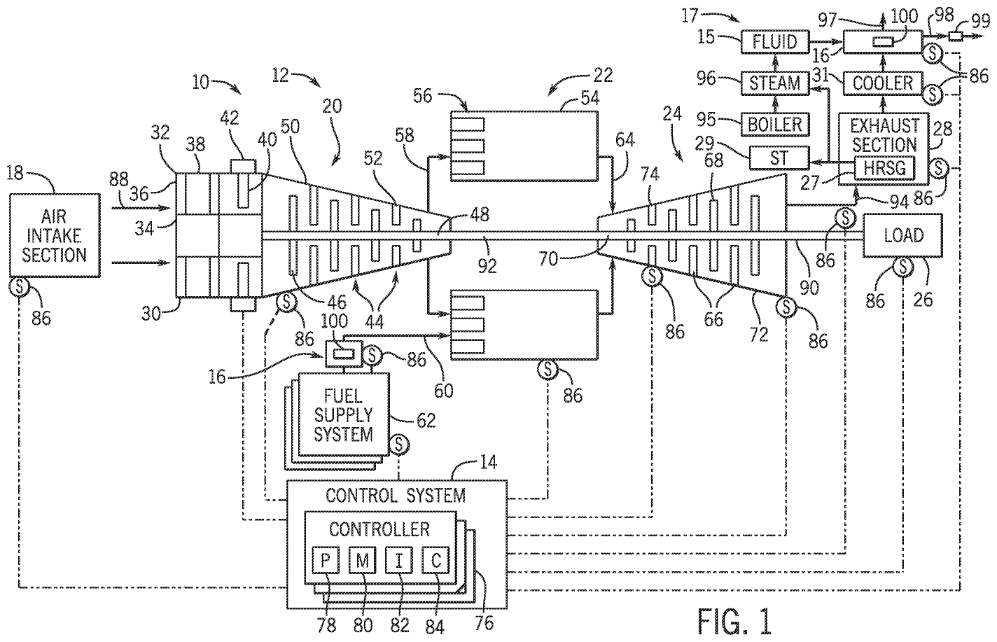

FIG. 1 is a block diagram of an embodiment of a gas turbine system 10 having a gas turbine engine 12 coupled to a control system 14. As discussed in further detail below, the gas turbine system 10 may include a gas treatment system 16 to treat one or more gases in the gas turbine system 10. The various features of the gas treatment system 16 are discussed in further detail below, and the various features may be used in any suitable combination with one another. However, before moving on to the gas treatment system 16, the gas turbine system 10 will be described as one possible context for use of the gas treatment system 16.

The gas turbine engine 12 includes an air intake section 18, a compressor section 20, a combustor section 22, a turbine section 24, a load 26, and an exhaust section 28. The air intake section 18 may include a duct having one or more silencer baffles, fluid injection systems (e.g., heated fluid injection for anti-icing), air filters, or any combination thereof. The compressor section 20 may include an upstream inlet duct 30 having a bell mouth 32, wherein the inlet duct 30 includes an air intake path between an inner hub 34 and an outer wall 36. The inlet duct 30 also includes stationary vanes 38 and inlet guide vanes (IGVs) 40. The inlet guide vanes 40 also may be coupled to one or more actuators 42, which are communicatively coupled to and controlled by the control system 14.

The compressor section 20 includes one or more compressor stages 44, wherein each compressor stage 44 includes a plurality of compressor blades 46 coupled to a compressor shaft 48 within a compressor casing 50, and a plurality of compressor vanes 52 coupled to the compressor casing 50. The compressor blades 46 and the compressor vanes 52 are arranged circumferentially about a central axis of the compressor shaft 48 within each compressor stage 44. The compressor stages 44 may include between 1 and 30 or more compressor stages. Additionally, the compressor stages 44 alternative between sets of the compressor blades 46 and sets of the compressor vanes 52 in the direction of air flow through the compressor section 20. In operation, the compressor stages 44 progressively compress the intake air flow before delivery to the combustor section 22.

The combustor section 22 includes one or more combustors 54 each having one or more fuel nozzles 56. In certain embodiments, the combustor section 22 may have a single annular combustor 54 extending around a central axis of the gas turbine engine 12. However, in some embodiments, the combustor section 22 may include 2, 3, 4, 5, 6, or more combustors 54 spaced circumferentially about the central axis of the gas turbine engine 12. The fuel nozzles 56 receive a compressed air 58 from the compressor section 20 and fuel 60 from one or more fuel supply systems 62, mix the fuel and air, and ignite the mixture to create hot combustion gases 64, which then exit each combustor 54 and enter the turbine section 24.

The turbine section 24 includes one or more turbine stages 66, wherein each turbine stage 66 includes a plurality of turbine blades 68 arranged circumferentially about and coupled to a turbine shaft 70 inside of a turbine casing 72, and a plurality of turbine vanes 74 arranged circumferentially about the turbine shaft 70. The turbine stages 66 may include between 1 and 10 or more turbine stages. Additionally, the turbine stages 66 alternate between sets of the turbine blades 68 and sets of the turbine vanes 74 in the direction of hot combustion gas flow through the turbine section 24. In operation, the hot combustion gases 64 progressively expand and drive rotation of the turbine blades 68 in the turbine stages 66.

The load 26 may include an electrical generator, a machine, or some other driven load. The load 26 may be disposed at the hot end of the gas turbine engine 12 as illustrated in FIG. 1, or the load 26 may be disposed at the cold end of the gas turbine engine 12 (e.g., adjacent the compressor section 20). The exhaust section 28 may include an exhaust duct, exhaust treatment equipment, silencers, or any combination thereof. In some embodiments, the exhaust section 28 may include and/or direct an exhaust flow through a heat exchanger and/or cooling system. For example, the heat exchanger may include a heat recovery steam generator (HRSG) 27 configured to transfer heat from the exhaust gas to water, thereby generating steam to drive a steam turbine 29. By further example, the cooling system may include one or more coolers 31, such as a direct contact cooler configured to spray a fluid (e.g., a liquid such as water) directly into the exhaust gas for directly cooling the exhaust gas. In certain embodiments, the gas turbine system 10 may include a combined cycle power plant having the gas turbine engine 12, the HRSG 27, and one or more steam turbines 29 driven by steam generated by the HRSG 27. The steam turbines 29, similar to the gas turbine engine 12, may be configured to drive electrical generators or other loads.

The control system 14 may include one or more controllers 76, each having a processor 78, memory 80, instructions 82 stored on the memory 80 and executable by the processor 78, and communications circuitry 84 configured to communicate with the gas treatment system 16. The control system 14 is also coupled to various sensors(S), as indicated by element number 86, distributed throughout the gas turbine system 10. For example, the sensors 86 may be coupled to and monitor conditions at the air intake section 18, the compressor section 20, the fuel supply systems 62, the combustors 54 of the combustor section 22, the turbine section 24, the load 26, the exhaust section 28, and the gas treatment system 16. The control system 14 is configured to receive feedback from the sensors 86 to facilitate adjustments of various operating parameters of the gas turbine engine 12, such as the air intake flow, the fuel supply from the fuel supply system 62 to the combustors 54, operation of exhaust treatment equipment in the exhaust section 28, operation of the gas treatment system 16 (e.g., movement of adsorption modules 100 to facilitate alternative period of adsorption and desorption), or any combination thereof. For example, the control system 14 may be configured to move the adsorption modules 100 along a linear path between a first position in a first flow path in a first duct and a second position in a second flow path in a second duct, wherein the adsorption module 100 is configured to adsorb an undesirable gas while positioned in the first position in the first duct and desorb the undesirable gas while positioned in the second position in the second duct. In this manner, the adsorption modules 100 can alternatively adsorb and desorb, and the gas treatment system 16 may stagger the movements of the different adsorption modules 100 to maintain at least one or more adsorption modules 100 in the first duct for adsorption while at least one or more adsorption modules 100 are disposed in the second duct for desorption.

As discussed in further detail below, the gas treatment system 16 is configured to remove and/or capture one or more undesirable gases (e.g., acid gases and/or exhaust emissions gases) from the incoming gas in sorbent materials in the adsorption modules 100. The undesirable gases are intended to cover any gases that may be undesirable in the fuel supply and/or exhaust gas. For example, the undesirable gases may include acid gases present in the fuel supply and the exhaust gases. By further example, the undesirable gases in the exhaust gases may include any exhaust emissions gases typically subject to regulation, including but not limited to, carbon oxides (CO_{X}) such as carbon dioxide (CO₂) and carbon monoxide (CO), nitrogen oxides (NO_{X}), sulfur oxides (SO_{X}) such as sulfur dioxide (SO₂), or any combination thereof. The disclosed embodiments are particularly well suited for gas adsorption of CO₂ from the exhaust gas. However, the following discussion is intended to cover each of these examples when referring to undesirable gases.

The gas treatment system 16 may be configured to receive a fluid 15 (e.g., purge gas, steam, etc.) from a fluid supply system 17, which may include one or more components or equipment that generates steam or another suitable fluid (e.g., liquid, gas or vapor) to desorb the undesirable gases from the adsorption modules 100. For example, the fluid supply system 17 may include the HRSG 27 and/or the steam turbine 29, which generate or output steam 96 as the fluid 15 for desorbing the undesirable gases from the adsorption modules 100. By further example, the fluid supply system 17 may include a boiler 95 (e.g., a standalone or external boiler) configured to generate steam 96 from a heat source (e.g., combustion in the boiler 95), wherein the steam 96 can be used as the fluid 15 for desorbing the undesirable gases from the adsorption modules 100. By further example, the fluid supply system 17 may include one or more other fluid supplies or equipment configured to generate steam 96 or another fluid (e.g., purge gas, liquid, or vapor) for use as the fluid 15 for desorbing the undesirable gases from the adsorption modules 100. In certain embodiments, a vacuum system may be used independently and/or in combination with the fluid supply system 17 to facilitate desorption of the undesirable gases from the adsorption modules 100. The vacuum system may include one or more vacuum pumps configured to lower a pressure of the adsorption modules 100 (e.g., lower pressure around the sorbent material), thereby creating a pressure differential to help separate the undesirable gases (i.e., adsorbed gases in the sorbent material) from the adsorption modules 100 and/or withdraw the undesirable gases from the gas treatment system 16. Accordingly, the vacuum system is configured to suction or pull the undesirable gases out of the adsorption modules 100. The vacuum system may be disposed at the respective adsorption modules 100 and/or downstream of the adsorption modules 100.

In operation, an incoming gas (e.g., exhaust gas 94 from turbine section 24, fuel from fuel supply system 62, flue gas, etc.) flows through a first flow path in the gas treatment system 16 and one or more of the adsorption modules 100 adsorbs the undesirable gases from the incoming gas, while the fluid 15 (e.g., steam) flows through a second flow path in the gas treatment system 16 and desorbs the undesirable gases from one or more of the adsorption modules 100. The gas exits the gas treatment system 16 as a treated gas 97 (e.g., treated exhaust gas, treated fuel, treated flue gas, etc.) that is lean in (or substantially free of) the undesirable gases, and the fluid 15 exits the gas treatment system 16 as a fluid 98 rich in the undesirable gases. The treated gas 97 may subsequently flow through additional equipment. For example, if the treated gas 97 is a treated exhaust gas or a treated flue gas, then the treated gas 97 may flow through an exhaust stack before discharging into the environment. If the treated gas 97 is a treated fuel gas, then the treated gas 97 may subsequently flow into the combustor section 22 of the gas turbine engine 12.

The gas treatment system 16 may include downstream equipment 99, such as a vacuum system, a fluid separation system, or any combination thereof, downstream from the adsorption modules 100. The vacuum system may include the equipment described above. The fluid separation system may include flash tanks, absorbers, or other equipment to separate the fluid 15 from the desorbed gas (e.g., undesirable gases). The gas treatment system 16 may use the downstream equipment 99 to separate and capture the undesirable gases (e.g., CO₂) from the fluid 15 (e.g., steam), such that the captured gas can be used for other applications. Accordingly, the gas treatment system 16 may be described as a carbon capture adsorption system.

In operation, the gas turbine system 10 receives air into the inlet duct 30 from the air intake section 18 as indicated by arrows 88, the inlet guide vanes 40 are controlled by the actuators 42 to adjust an angular position of the inlet guide vanes 40 for adjusting air flow into the compressor section 20, and the compressor section 20 is configured to compress the air flow being supplied into the combustor section 22. For example, each stage 44 of the compressor section 20 compresses the air flow with a plurality of the blades 46. The compressed air flow 58 then enters each of the combustors 54, where the fuel nozzles 56 mix the compressed air flow with fuel 60 from the fuel supply system 62. The mixture of fuel and air is then combusted in each combustor 54 to generate the hot combustion gases 64, which flow into the turbine section 24 to drive rotation of the turbine blades 68 in each of the stages 66. The rotation of the turbine blades 68 drives rotation of the turbine shaft 70, which in turn drives rotation of the load 26 and the compressor section 20 via a shaft 90 coupled to the load 26 and a shaft 92 coupled to the compressor shaft 48. The turbine section 24 then discharges an exhaust gas 94 into the exhaust section 28 for final treatment and discharge into the environment.

In the illustrated embodiment, the gas turbine system 10 has the gas treatment system 16 coupled to one or more fuel supply systems 62 and the exhaust section 28. However, the gas treatment system 16 also may be coupled to one or more reciprocating piston-cylinder engines, furnaces, boilers, chemical reactors, gasification systems having one or more gasifiers configured to produce a synthesis gas, or other industrial equipment. Each of these gas treatment systems 16 has the features described in further detail below, and the disclosed embodiments are intended to be used in various combinations with one another in all of the foregoing applications.

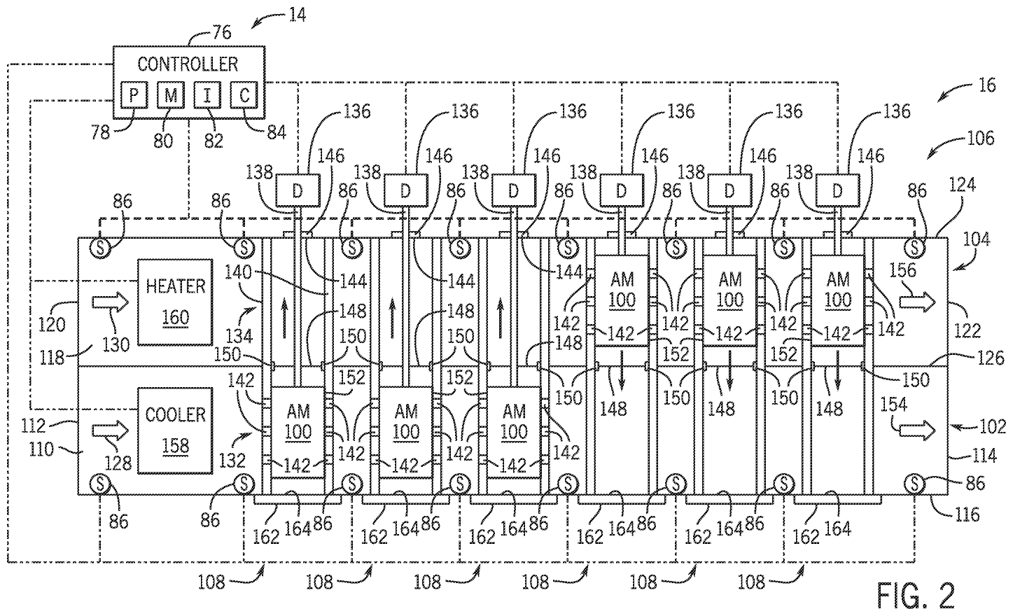

FIG. 2 is a schematic view of an embodiment of the gas treatment system 16 of FIG. 1, further illustrating details of the adsorption modules 100 moving linearly back and forth between ducts 102 and 104. As illustrated, the gas treatment system 16 includes an adsorption system 106 having a plurality of movable adsorption assemblies 108 configured to move the adsorption modules 100 between the ducts 102 and 104. For example, the adsorption system 106 may be configured to move the adsorptions modules 100 in a staggered arrangement in the ducts 102 and 104, such that one or more of the adsorption modules 100 are positioned in the duct 102 for adsorption of undesirable gases while one or more of the adsorption modules 100 are positioned in the duct 104 for desorption of undesirable gases. The adsorption modules 100 may be configured to move crosswise (e.g., perpendicular) to longitudinal axes of the ducts 102 and 104, while also moving parallel to one another (e.g., along parallel paths of travel in linear directions). Various aspects of the adsorption modules 100 are discussed in further detail below.

The adsorption modules 100 may be disposed entirely within the ducts 102 and/or 104 during normal operation of the gas treatment system 16. The duct 102 has a flow path 110 extending lengthwise through the duct 102 between an inlet 112 and an outlet 114, wherein a sidewall 116 of the duct 102 extends about the flow path 110. For example, the sidewall 116 may include a rectangular sidewall defining a rectangular shape of the duct 102. Similarly, the duct 104 has a flow path 118 extending lengthwise through the duct 104 from an inlet 120 to an outlet 122, wherein a sidewall 124 of the duct 104 extends about the flow path 118. For example, the sidewall 124 may define a rectangular sidewall 124 defining a rectangular shape of the duct 104. The ducts 102 and 104 may be disposed directly adjacent to one another (e.g., in contact with one another), such that ducts 102 and 104 have an intermediate wall 126 disposed directly between the flow path 110 of the duct 102 and the flow path 118 of the duct 104. In certain embodiments, the intermediate wall 126 may be a single shared wall between the ducts 102 and 104. However, in some embodiments, the intermediate wall 126 may include the sidewalls 116 and 124 of the ducts 102 and 104. Although the illustrated embodiment depicts linear ducts 102 and 104, the ducts 102 and 104 may have one or more turns, curves, angled portions, or any combination thereof. Additionally, the ducts 102 and 104 may be sized the same or different from one another, and the ducts 102 and 104 may have the same or different shapes. The duct 102 may also be described as an adsorption duct (e.g., adsorbing undesirable gases into sorbent materials of the adsorption modules 100), while duct 104 may be described as a desorption duct 104 (e.g., desorbing undesirable gases from the sorbent materials of the adsorption modules 100). The ducts 102 and 104 may be configured to flow a variety of fluid flows, such as gases, liquids, or multi-phase fluid flows.

In the illustrated embodiment, the duct 102 is configured to receive and pass a fluid flow 128, which may include a fuel, an exhaust gas, or another untreated gas having undesirable gases. For example, the undesirable gases may include carbon oxides (CO_{X}) such as carbon dioxide (CO₂) and carbon monoxide (CO), nitrogen oxides (NO_{X}), sulfur oxides (SO_{X}) such as sulfur dioxide (SO₂), hydrogen sulfide (H₂S), or any combination thereof. The duct 104 is configured to receive and pass a fluid flow 130, which may include steam, an inert gas such as nitrogen, air, or another fluid flow. As discussed in further detail below, each movable adsorption assembly 108 is configured to move the respective adsorption module 100 between the flow path 110 in the duct 102 and the flow path 118 and the duct 104 to alternatingly adsorb undesirable gases from the fluid flow 128 and desorb the undesirable gases in response to heat added by the fluid flow 130 in the duct 104.

Each movable adsorption assembly 108 has the adsorption module 100 movably coupled to a linear position assembly 132, which extends between and enables movement of the adsorption module 100 from the duct 102 to the duct 104 and vice versa. The linear positioning assembly 132 may include a plurality of rail assemblies 134 coupled to the ducts 102 and 104 and the adsorption module 100. Additionally, the linear positioning assembly 132 includes a drive 136 coupled to a drive line 138, wherein the drive line 138 is coupled to the respective adsorption module 100.

As discussed in further detail below, each rail assembly 134 may include a mating set of a rail 140 and one or more slides 142 configured to move along the rail 140 between the ducts 102 and 104. For example, the slides 142 may include wheels, blocks of low friction material, mating rails, or any combination thereof. In certain embodiments, the rails 140 are coupled to the ducts 102 and 104 and extend all or substantially all of the distance between the sidewalls 116 and 124, while the slides 142 are coupled to each of the adsorption modules 100. In the illustrated embodiment, the linear positioning assembly 132 has rail assemblies 134 disposed on opposite sides of each adsorption module 100. However, the rail assemblies 134 may be disposed on only one side, opposite sides, four corners, or any combination of positions, along each respective adsorption module 100.

The drive line 138 extends between the drive 136 and the adsorption module 100, wherein the drive line 138 may include a rigid bar or rod, a flexible cable, a chain, a rope, or any combination thereof. The drive 136 may include an electric motor, a fluid driven piston cylinder assembly, a combustion engine, a gear assembly, a manual wheel or actuator assembly, or any combination thereof. The drive line 138 may be configured to move linearly, rotate, or any combination thereof, to cause linear motion of the adsorption module 100 along a linear path of travel defined by the rail assemblies 134 of the linear positioning assembly 132 between the duct 102 and the duct 104. The drive line 138 also may extend through the sidewall 124, such as through an opening 144 in the sidewall 124, wherein the drive line 138 may be further supported by a bushing or seal 146 at the sidewall 124. For example, the bushing or seal 146 may be an annular structure configured to seal about the drive line 138 to block leakage of the fluid flow 130 out of the duct 104 into the surrounding environment. In some embodiments, the drive 136 may be disposed in a sealed enclosure along the sidewall 134 and/or inside of the duct 104.

At each linear positioning assembly 132, the adsorption module 100 is configured to move between the ducts 102 and 104 via an opening 148 in the intermediate wall 126. For example, the opening 148 may have a size and shape contoured or similar to an outer perimeter 152 of the adsorption module 100. Additionally, the opening 148 may be surrounded or bordered by a seal 150. For example, as discussed in further detail below, the seal 150 may include a brush seal that contacts the outer perimeter 152 of the adsorption module 100 at all times and positions of the adsorption module 100 as the adsorption module 100 moves between the duct 102 and the duct 104. Accordingly, the interface between the seal 150 and the outer perimeter 152 blocks leakage between the fluid flow 128 in the duct 102 and the fluid flow 130 in the duct 104. As illustrated in FIG. 2, three of the linear positioning assemblies 132 have the adsorption modules 100 disposed in the duct 102, such that the adsorption modules 100 are actively adsorbing the undesirable gases from the fluid flow 128. However, three of the adsorption modules 100 are also disposed in the duct 104, such that the undesirable gases can be desorbed from the adsorption modules 100 for regeneration of the adsorption modules 100 prior to further use in the duct 102. As discussed in further detail below, the gas treatment system 16 is configured to alternate positions of the adsorption modules 100 between the ducts 102 and 104, such that one or more of the adsorption modules 100 are adsorbing undesirable gases in the duct 102 while one or more of the adsorption modules 100 are being regenerated by desorption in the duct 104.

The controller 76 is configured to control movement and positioning of the adsorption modules 100 depending on various parameters, such as rates of adsorption in the duct 102 and rates od desorption in the duct 104. As illustrated in FIG. 2, in the duct 102, the fluid flow 128 treated by the adsorption modules 100 results in adsorption of the undesirable gases, such that the fluid flow 128 becomes treated and generates a treated fluid flow 154 being discharged through the outlet 114 of the duct 102. For example, the treated fluid flow 154 may be entirely or substantially free of the undesirable gases, such as CO₂, H₂S, SO₂, NO₂, or any combination thereof. In the duct 104, the fluid flow 130 provides heat to facilitate desorption of the undesirable gases from the adsorption modules 100. For example, the fluid flow 130 may include steam configured to flow through and around each of the adsorption modules 100 in the duct 104, thereby helping to heat the adsorption modules 100 and cause desorption of the undesirable gases out of the adsorption modules 100 for subsequent capture, cooling, and compression. Thus, the duct 104 discharges a cooled fluid flow 156, such as a cooled steam. In certain embodiments, the undesirable gases desorb from the adsorption modules 100 into the duct 104, which then carries the desorbed gases along with the cooled fluid flow 156 for subsequent capture, cooling, and compression. Alternatively, or additionally, the desorbed gases may be separated and captured at each individual adsorption module 100.

The gas treatment system 16 also may include one or more temperature control systems, such as coolers 158 and heaters 160. For example, the fluid flow 128 entering the duct 102 may be a heated fluid flow, such as an exhaust gas, and thus one or more coolers 158 may be disposed in the duct 102 upstream of the movable adsorption assemblies 108. The coolers 158 are configured to cool the fluid flow 128 prior to flowing through and/or around the adsorption modules 100. In certain embodiments, if the fluid flow 128 is sufficiently cool or below a threshold temperature, the duct 102 may exclude the coolers 158 and/or the controller 76 may not operate the coolers 158. Similarly, in the duct 104, the fluid flow 130 may be heated by one or more heaters 160 to help raise the temperature of the fluid flow 130 prior to passage through the adsorption modules 100 being regenerated in the duct 104. For example, each heater 160 may be an electric resistance heater, a heat exchanger, or another form of heater configured to raise the temperature high enough to help induce desorption of the undesirable gases from the adsorption modules 100. In certain embodiments, if the fluid flow 130 is sufficiently hot or above a threshold temperature, the duct 104 may exclude the heaters 160 and/or the controller 76 may not operate the heaters 160.

The gas treatment system 16 also may include maintenance features to help inspect, repair, service, change, or otherwise modify the adsorption modules 100 in each of the movable adsorption assemblies 108. Accordingly, each of the movable adsorption assemblies 108 may include an access panel 162 removably coupled to the sidewall 116 over an access opening 164 aligned with the linear positioning assembly 132 and the respective adsorption module 100. Accordingly, as discussed in further detail below, the access panel 162 may be removed to allow visual inspection and/or removal of the adsorption module 100 through the access opening 164. The access panels 162 may include hinged doors, bolted doors, metal panels, glass or otherwise clear panels to facilitate viewing, or any combination thereof.

As further illustrated, the control system 14 has the controller 76 coupled to each of the drives 146 of the linear positioning assemblies 132, the one or more coolers 158, the one or more heaters 160, and a plurality of sensors 86 disposed throughout each of the ducts 102 and 104. As discussed above with reference to FIG. 1, each of the sensors is designated with an S, and thus the sensors are not all numbered in the illustrated embodiment. However, each of the sensors 86 may be disposed upstream and/or downstream of each of the illustrated components, such as the adsorption modules 100, the cooler 158, and the heater 160 in each of the ducts 102 and 104. The sensors 86 may include temperature sensors, flow rate sensors, pressure sensors, fluid composition sensors, or any combination thereof. For example, the sensors 86 may include gas composition sensors configured to monitor the rate of adsorption of the undesirable gases from the adsorption modules 100 disposed in the duct 102, and to monitor the rate of desorption of the undesirable gases from the adsorption modules 100 disposed in the duct 104.

The rate of adsorption or desorption of the undesirable gases may help to facilitate control by the controller 76 of the movement of the adsorption modules 100 between the duct 102 and the duct 104. For example, if the adsorption rate gradually reduces to a level below a threshold adsorption rate, then the controller 76 may be configured to operate the drive 136 to move the adsorption module 100 from the duct 102 to the duct 104, such that the adsorption module 100 can undergo regeneration by desorbing the undesirable gases from the adsorption module 100 via the fluid flow 130. Similarly, if the desorption rate in the duct 104 gradually reduces to a level below a threshold desorption rate, then the controller 76 may be configured to operate the drive 136 to move the adsorption module 100 from the duct 104 to the duct 102, such that the adsorption module 100 can function to adsorb the undesirable gases from the fluid flow 128 in the duct 102. Accordingly, the sensor feedback from the sensors 86 may facilitate control by the controller 76 to cycle the adsorption modules 100 back and forth between the ducts 102 and 104 to ensure there are always one or more adsorption modules 100 efficiently adsorbing the undesirable gases in the duct 102 while the other adsorption modules 100 are being regenerated in the duct 104.

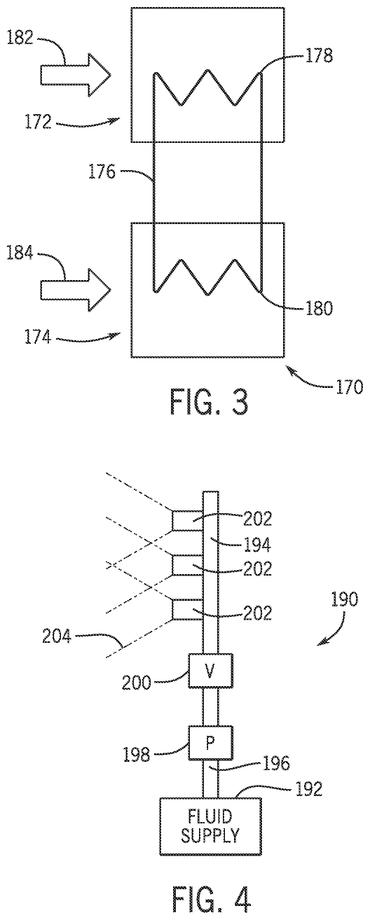

The controller 76 also may be configured to control the temperature in each of the ducts 102 and 104 via control of the cooler 158 and the heater 160. For example, the controller 76 may be configured to control the temperature in the duct 102 to remain at or below a threshold temperature, while the controller 76 may be configured to control the heater 160 to maintain the temperature in the duct 104 at or above a threshold temperature. Further details of the adsorption modules 100, the movable adsorption assemblies 108, the cooler 158, and the heater 160 are discussed in further detail below with reference to FIGS. 3-14.

FIG. 3 is a schematic view of an embodiment of a temperature control system 170 configured to provide temperature control for the cooler 158 and/or the heater 160 of FIG. 2. For example, the temperature control system 170 may include a heat exchanger 172, a heat exchanger 174, and a fluid circuit 176 extending between and through the heat exchangers 172 and 174. For example, the fluid circuit 176 may include a plurality of coils or winding tubes 178 in the heat exchanger 172 and a plurality of coils or winding tubes 180 in the heat exchanger 174.

In the illustrated embodiment, the temperature control system 170 may be configured to transfer heat between a relatively lower temperature fluid flow 182 passing through the heat exchanger 172 and a relatively higher temperature fluid flow 184 passing through the heat exchanger 174. The fluid circuit 176 circulates a working fluid through the coils or tubes 178 and 180 in the heat exchangers 172 and 174, such that heat can be transferred between the relatively lower and higher temperature fluid flows 182 and 184. For example, the lower temperature fluid flow 182 is configured to transfer heat away from the working fluid in the coils or tubes 178, while the higher temperature fluid flow 184 is configured to transfer heat into the working fluid in the coils or tubes 180. Accordingly, the heat exchanger 172 also may be described as a heater, because the heated working fluid passing through the coils or tubes 178 causes an increase and temperature of the lower temperature fluid flow 182. The heat exchanger 174 may be described as a cooler, because the relatively cooler working fluid in the coils or tubes 180 is configured to cool or lower the temperature of the higher temperature fluid flow 184.

In certain embodiments, the temperature control system 170 may be disposed in the gas treatment system 16 in a variety of ways. For example, the heat exchanger 172 may correspond to the heater 160 while the heat exchanger 174 corresponds to the cooler 158, such that the entire temperature control system 170 is disposed within the ducts 102 and 104. Alternatively, or additionally, the heat exchanger 172 may be disposed in the duct 104 as the heater 160, while the heat exchanger 174 is disposed outside of the gas treatment system 16 in the path of a completely different higher temperature fluid flow 184. Similarly, the heat exchanger 174 may be disposed in the duct 102 and serve as the cooler 158, while the heat exchanger 172 may be disposed completely outside of the gas treatment 16 within a lower temperature fluid flow 182 separate from the gas treatment system 16. However, a variety of the foregoing configurations may be used alone or in combination with one another, as well as combinations with other types of coolers 158 and heaters 160.

FIG. 4 is a schematic of an embodiment of a direct heat exchange system 190 configured to provide heating or cooling depending on the configuration of the system 190. For example, the illustrated direct heat exchange system 190 includes a fluid supply 192, a fluid distribution manifold 194, and a conduit 196 extending between the fluid supply 192 and the distribution manifold 194. The fluid conduit 196 may also include one or more flow control features, such as a fluid pump 198 and a fluid control valve 200. The fluid pump 198 is configured to pump a fluid flow from the fluid supply 192, while the fluid control valve 200 can be moved between open and closed valve positions to adjust a flow rate of the fluid flow from the fluid supply 192. Collectively, the fluid pump 198 and the fluid control valve 200 are configured to control fluid flow from the fluid supply 192 to the fluid distribution manifold 194. The fluid distribution manifold 194 also may include a plurality of fluid nozzles 202 configured to output a spray 204 of fluid from the fluid supply 192. For example, the fluid supply 192 may include a liquid or gas at a desired temperature to provide heating or cooling directly in the fluid flow 128 or the fluid flow 130 of the gas treatment system 16. Accordingly, the direct heat exchange system 190 may be configured as the cooler 158 by injecting a relatively lower temperature fluid into the fluid flow 128, or the direct heat exchanger system 190 may be configured as the heater 160 by injecting a relatively higher temperature fluid flow into the fluid flow 130. The fluid supply 192 may include water, inert gas such as nitrogen, air, or another suitable gas or liquid.

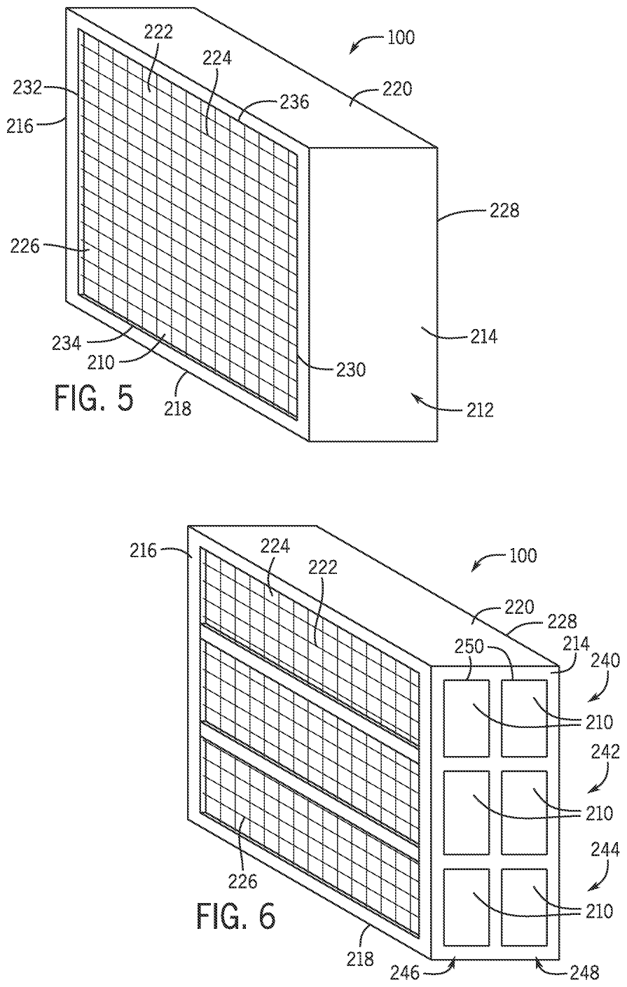

FIG. 5 is a perspective view of an embodiment of the adsorption module 100 of FIGS. 1 and 2. As illustrated, the adsorption module 100 includes a sorbent cartridge 210 disposed in a framework 212. The framework 212 includes sidewalls 214, 216, 218, and 220, which may collectively define a rectangular panel structure of the framework 212. For example, the sidewalls 214 and 216 may be flat rectangular panels that are parallel to one another, while the sidewalls 218 and 220 may be flat rectangular panels that are parallel to one another and perpendicular to the sidewalls 214 and 216. The sidewalls 214 and 216 or the sidewalls 218 and 220 also may couple to the slides 142 of the rail assembly 134 as discussed above with reference to FIG. 2.

The sorbent cartridge 210 may include a sorbent material 212 surrounded and contained by a screen 224. The sorbent material 212 may include a plurality of sorbent particles, beads, balls, strips, or discrete elements of equal or different sizes and shapes. The screen 224 may have a wire mesh with sufficiently small openings to hold the sorbent material 212 while enabling fluid flow along the flow paths 110 and 118. In certain embodiments, the screen 224 extends along opposite upstream and downstream sides 226 and 228 of the sorbent cartridge 210, around lateral sides 230, 232, 234, and 236, or any combination thereof. Thus, the screen 224 enables relatively free flow of the fluid flow 128 or the fluid flow 130 through the sorbent material 222 held in place by the screen 224. In some embodiments, the screen 224 may be disposed only along the upstream and downstream sides 226 and 228, while a solid sidewall may be disposed along the lateral sides 230, 232, 234, and 236 of the sorbent cartridge 210.

Additionally, in certain embodiments, the sorbent cartridge 210 may be removable from the framework 212 for replacement or servicing as needed during operation of the gas treatment system 16. For example, the sorbent cartridge 210 may be removable from the upstream side 226 and/or the downstream side 228 of the framework 212. Although the embodiment of FIG. 5 shows one sorbent cartridge 210, embodiments of the adsorption module 100 may include any number and configuration of sorbent cartridges 210, which may be removably disposed within the framework 212.

FIG. 6 is a perspective view of an embodiment of the adsorption module 100 having a plurality of sorbent cartridges 210 disposed within the framework 212. The features of the sorbent cartridge 210 are substantially the same as discussed above with reference to FIG. 5. However, the embodiment of FIG. 6 has a plurality of smaller sorbent cartridges 210 arranged in rows 240, 242, and 244, and columns 246 and 248. The column 248 is disposed along the upstream side 226, while the column 248 is disposed along the downstream side 228. The illustrated sorbent cartridges 210 may be sized and configured substantially the same as one another. However, in some embodiments, the adsorption module 100 may have a plurality of differently sized and configured sorbent cartridges 210, which may include different dimensions, different sorbent materials 222, different screen arrangements of the screens 224, or any combination thereof. As illustrated, the adsorption module 100 has three rows 240, 242, and 244; however, the adsorption module 100 may have any number of rows (e.g., 1, 2, 3, 4, 5, 6, 7, 8, 9, 10, or more rows). Similarly, the illustrated adsorption module 100 has two columns 246 and 248; however, the adsorption module 100 may have any number of columns (e.g., 1, 2, 3, 4, 5, 6, 7, 8, 9, 10, or more columns).

In the illustrated embodiment, the framework 212 includes a plurality of cartridge openings 250 disposed in the sidewall 214, such that each of the sorbent cartridges 210 may be inserted and removed through one of the cartridge opening 250 of the framework 212. Accordingly, the adsorption module 100 includes the cartridge openings 250 to facilitate easy inspections, servicing, replacements, and other maintenance actions for each of the sorbent cartridges 210 independently from one another. Additionally, the entire adsorption module 100, such as the adsorption modules 100 of FIGS. 5 and 6, may be configured to be inserted and removed through the access openings 164 of the duct 102 as discussed above with reference to FIG. 2.

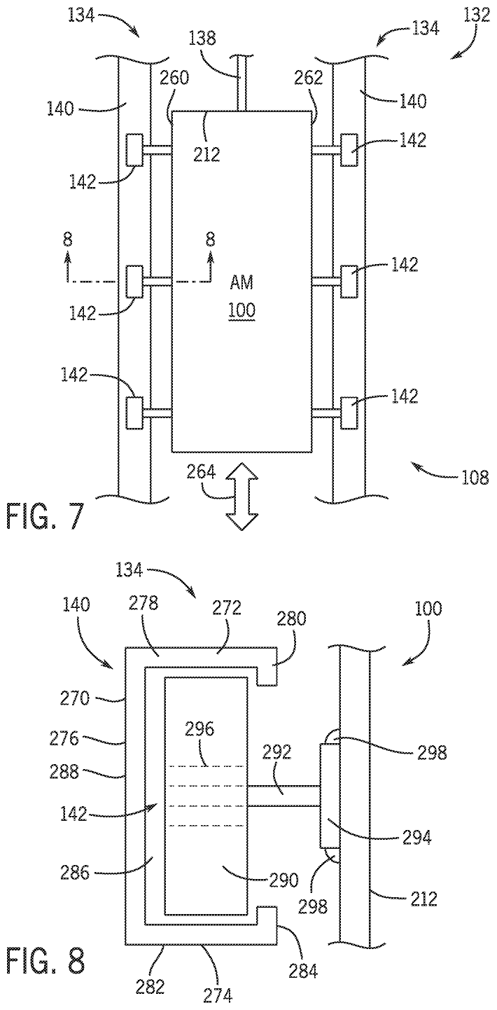

FIG. 7 is a partial schematic view of an embodiment of one of the movable adsorption assemblies 108 as illustrated in FIG. 2. In the illustrated embodiment, the movable adsorption assembly 108 has the adsorption module 100 slidingly disposed along the linear positioning assembly 132 via rail assemblies 134 disposed on opposite sides 260 and 262 of the adsorption module 100. For example, each side 260 and 262 of the adsorption module 100 may have one or more slides 142, which are configured to slide or move along the corresponding rails 140 in a linear direction as indicated by arrow 264 (e.g., a linear path of travel). The opposite sides 260 and 262 may correspond to any of the opposite sides discussed above with reference to FIGS. 5 and 6. For example, the opposite sides 260 and 262 may correspond to the upstream and downstream sides 226 and 228, the sidewalls 214 and 216, or the sidewalls 218 and 220 of the framework 212. In some embodiments, each of the opposite sides 260 and 262 of the adsorption module 100 may have a plurality of the rail assemblies 134, such as rail assemblies 134 disposed along the corners or edges of the opposite sides 260 and 262, one or more intermediate locations along the sides 260 and 262, or a combination thereof. The illustrated rail assemblies 134 have three slides 142 disposed in each rail 140 on each of the sides 260 and 262. However, certain embodiments of the rail assemblies 134 may include 2, 3, 4, 5, 6, 7, 8, 9, 10, or more slides 142 disposed in each of the rails 140.

The slides 142 may include rotatable wheels, blocks of low friction material, or a combination thereof. For example, the blocks of low friction material may include low friction metals or metal coatings, low fiction plastics or plastic coatings, low friction ceramics or ceramic coatings, nylon, polytetrafluoroethylene (PTFE), diamond-like carbon (DLC) coatings, or any combination thereof. The slides 142 also may be partially or entirely captured within each of the rails 140, such that the slides 142 cannot become dislodged from the rails 140 when moving the adsorption module 100 in the linear direction 264. Additionally, as discussed above, the rails 140 generally extend an entire distance across each of the ducts 102 and 104, such that the rail assemblies 134 enable movement of the adsorption module 100 entirely into one of the ducts 102 or 104. Additional details of the rail assemblies 134 are discussed in further detail below.

FIG. 8 is a partial cross-sectional view of an embodiment of the rail assembly 134 of FIGS. 2 and 7, further illustrating details of the engagement between the rails 140 and the slides 142. As illustrated, the rail 140 may include a C-shaped cross-section 270 having upper and lower walls 272 and 274 coupled together via a sidewall 276. For example, the upper wall 272 may include a flat plate 278 having a radially inward lip 280, while the lower wall 274 may have a flat plate 282 with a radially inward lip 284. For example, the flat plates 278 and 282 may be substantially parallel to one another, while the radially inward lips 280 and 284 may be protruding inwardly toward one another about an interior channel 286. The sidewall 276 also may include a flat plate 288 coupled to the flat plates 278 and 282. The C-shaped cross-section 270 extends linearly in the linear direction 264 as indicated in FIG. 7, such that the slide 142 is able to move along the interior channel 286 between the flat plates 278 and 282 of the upper and lower walls 272 and 274. Additionally, the radially inward lips 280 and 284 are configured to block the slide 142 from inadvertently moving out of the C-shaped cross-section 270 of the rail 140.

As discussed above, the slide 142 may be configured as a rigid low friction sliding material, a rotatable wheel, or a combination thereof. In the illustrated embodiment, the slide 142 has a wheel 290 rotatably coupled to a shaft 292, which in turn is coupled to the framework 212 of the adsorption module 100 via a mount 292. The wheel 290 also may include a bearing 296 disposed about the shaft 292, thereby helping to facilitate rotation of the wheel 290 about the shaft 292. The mount 294 may be configured to fixedly or removably couple to the framework 212. For example, the mount 294 may be welded to the framework 212 via one or more welded joints 298. In some embodiments, the wheel 290 may represent a block of low friction material to facilitate sliding along the rail 140, such as a low friction metal, plastic, ceramic, or other suitable material.

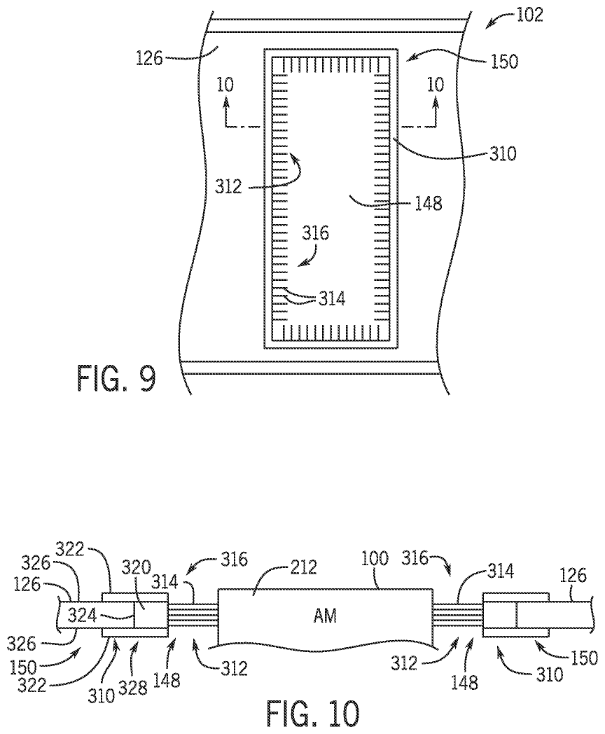

FIG. 9 is a schematic view of an embodiment of the moveable adsorption assembly 108 of FIG. 2, further illustrating details of the seal 150 disposed about the opening 148 in the intermediate wall 126 between the first and second ducts 102 and 104. The opening 148 and the seal 150 facilitate movement of the adsorption module 100 between the duct 102 and the duct 104 as discussed above with reference to FIG. 2. As illustrated, the opening 142 is a rectangular shaped opening contoured to the rectangular shape of the adsorption module 100. The seal 150 is disposed about the perimeter of the opening 148.

In certain embodiments, the seal 150 may include a seal frame or border 310 disposed about the opening 148, and a flexible seal material 312 disposed along the seal frame or border 310. For example, the seal frame or border 310 may have a rectangular shape contoured or matched to the rectangular shape of the opening 148, and the flexible seal material 312 may include flexible metal, plastic, rubber, or other materials depending on the temperatures of the fluid flow 128 and the fluid flow 130. For example, in certain embodiments, the flexible seal material 312 may include a plurality of fibers 314 of a brush seal 316. Accordingly, the bush seal 316 may include a plurality of closely spaced fibers 314 made of the flexible seal material 312 to facilitate a dynamic seal as the adsorption module 100 moves through the opening 148 between the duct 102 and the duct 104.

Regardless of the position of the adsorption module 100, the seal 150 is configured to maintain a seal along the framework 212 of the adsorption module 100 to help block leakage of the fluid flows 128 and 130 between the ducts 102 and 104. In some embodiments, the seal 150 may include a plurality of different types of seals, such as the brush seal 316 having the fibers 314, metal seals, plastic seals, rubber seals, fabric seals, or any combination thereof. The seal 150 may include a single continuous strip of the flexible seal material 312, discrete pieces of the flexible seal material 312 (e.g., fibers 314 of the brush seal 316), overlapping flaps of the flexible seal material 312, or any combination thereof.

FIG. 10 is a partial cross-sectional view of the movable adsorption assembly 108 taken along line 10-10 of FIG. 9, further illustrating the adsorption module 100 sealed against the seal 150 within the opening 148 of the intermediate wall 126. As illustrated, the seal 150 has the fibers 314 of the brush seal 316 disposed against and in contact with the framework 212 of the adsorption module 100. The fibers 314 are coupled to and supported by the seal frame or border 310, which includes an edge wall 320 and opposite sidewalls 322. The edge wall 320 is configured to extend along an inner edge 324 of the opening 148, while the sidewalls 322 are configured to extend along opposite side surfaces 326 of the intermediate wall 126. Collectively, the edge wall 320 and the opposite side walls 322 define a C-shaped structure 328, which is configured to be self-retained about the intermediate wall 126 at the opening 148. However, in certain embodiments, the C-shaped structure 328 of the seal frame or border 310 may be further coupled to the intermediate wall 126 via fixed joints, removable fasteners, or a combination thereof. For example, the fixed joints may include welded joints, brazed joints, or integrally formed structures. The removable fasteners may include threaded bolts, clamps, springs or hooks, dovetail joints, or any combination thereof.

Again, the illustrated seal 150 has the fibers 314 of the brush seal 316 coupled to the seal frame or border 310. As illustrated, the fibers 314 are directly coupled to the edge wall 320. As the adsorption module 100 moves along the linear positioning assembly 132 between the duct 102 and the duct 104, the fibers 314 of the brush seal 316 are configured to provide sealing between the intermediate wall 126 and the adsorption module 100. In other embodiments, the fibers 314 may be replaced or supplemented with other sealing features, such as flexible flaps, flexible gaskets, or any combination thereof. These flexible flaps or gaskets may be made of flexible metals, plastics, or other materials.

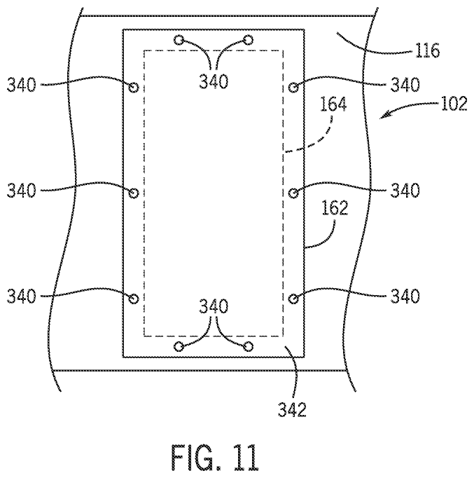

FIG. 11 is a schematic view of an embodiment of the moveable adsorption assembly 108 of FIG. 2, further illustrating details of the access panel 162 disposed over the access opening 164 in the sidewall 116 of the duct 102 to enable insertion and removal of the adsorption module 100. In the illustrated embodiment, the access panel 162 is a rectangular shaped panel disposed over the access opening 164, which also may be a rectangular shaped access opening. The access panel 162 is removably coupled to the sidewall 116 of the duct 102 via a plurality of fasteners 340. For example, the fasteners 340 may include threaded bolts, threaded nuts, threaded shafts, clips, clamps, rotatable latches, hinges, or any combination thereof. Details of the fasteners 340 will be discussed in further detail below. The fasteners 340 are disposed about a border or flange 342 of the access panel 162, wherein the border or flange 342 extends or overlaps with a portion of the sidewall 116 outside of the access opening 164. The fastener 340 may be loosened, removed, or adjusted to enable removal or movement of the access panel 162 away from the access opening 164, thereby enabling access to inspect, insert, or remove the adsorption module 100 relative to the interior of the duct 102 as shown in FIG. 2.

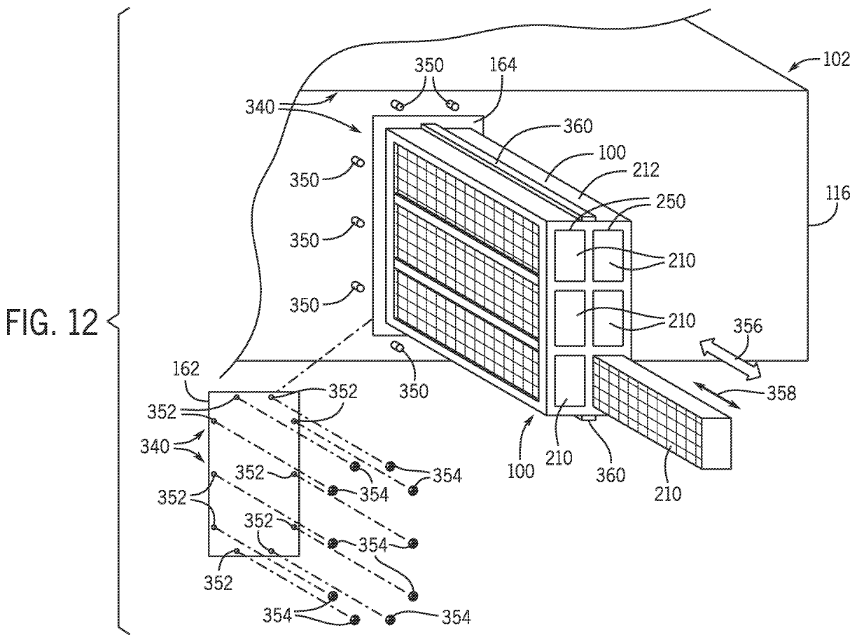

FIG. 12 is a partial perspective view of an embodiment of the gas treatment system 16 of FIG. 2, further illustrating details of the adsorption module 100 partially removed and protruding from the sidewall 116 of the duct 102 via the access opening 164. As illustrated, the access panel 162 is removed from the access opening 164, thereby exposing the access opening 164 and enabling the removal of the adsorption module 100. The fasteners 340 may include a plurality of threaded shafts 350 coupled to the sidewall 116, while the access panel 162 includes a plurality of shaft openings 352 to receive the threaded shafts 350. The fasteners 340 also may include a plurality of threaded nuts 354 configured to couple with the threaded shafts 350 on the exterior of the access panel 162, thereby removably securing the access panel 162 to the sidewall 116. In the illustrated embodiment, the access panel 162 and the threaded nuts 354 are removed from the duct 102, thereby allowing access and removal of the adsorption module 100 from the duct 102.

The linear positioning assembly 132 enables the adsorption module 100 to slide linearly out of the duct 102 as indicated by arrow 356, while the cartridge openings 250 in the framework 212 of the adsorption module 100 enable each of the sorbent cartridges 210 to be inserted and removed as indicated by arrow 358. For example, each of the adsorption modules 100 may be independently accessed via the respective access panels 162 and access openings 164 as illustrated in FIG. 2, while the remaining adsorption modules 100 may continue to operate in either the duct 102 or the duct 104. While one of the adsorption modules 100 is being inspected, removed, installed, or replaced as illustrated in FIG. 12, one or more of the sorbent cartridges 210 also may be independently accessed and moved via the cartridge openings 250. For example, each of the individual sorbent cartridges 210 can be linearly moved out of the cartridge openings 250, inspected, replaced, and reinstalled back into the respective cartridge openings 250. As further illustrated in FIG. 12, each of the rail assemblies 134 may include a rail extension 360, which is configured to extend outwardly from the sidewall 116 when withdrawing the adsorption module 100 from the duct 102. When installing the adsorption module 100 back into the duct 102, the rail extension 360 may slide back into the interior of the duct 102.

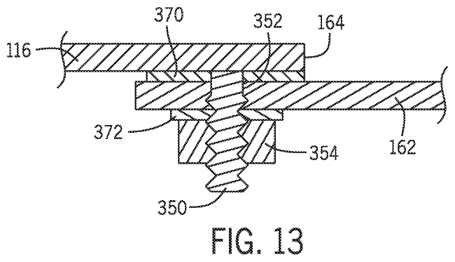

FIG. 13 is a partial cross-sectional view of an embodiment of the access panel 162 coupled to the sidewall 116 of the duct 102 at the access opening 164 as illustrated in FIG. 12. In the illustrated embodiment, the threaded shaft 350 is protruding outwardly from the sidewall 116, the access panel 162 is disposed about the threaded shaft 350 via the shaft opening 352, and the threaded nut 354 is threaded onto the threaded shaft 350 to compressively secure the access panel 162 onto the sidewall 116. In the illustrated embodiment, the access panel 162 may be sealed relative to the sidewall 116 via a flat seal or gasket 370 disposed between the access panel 162 and the sidewall 116. Additionally, the threaded nut 354 may be secured to the threaded shaft 350 with an intermediate washer 372 (e.g., a lock washer) between the threaded nut 354 and the access panel 162. For example, the washer 372 may be a conical shaped washer or Belleville washer, a wave washer, a split or spring lock washer, a toothed lock washer, or any combination thereof.

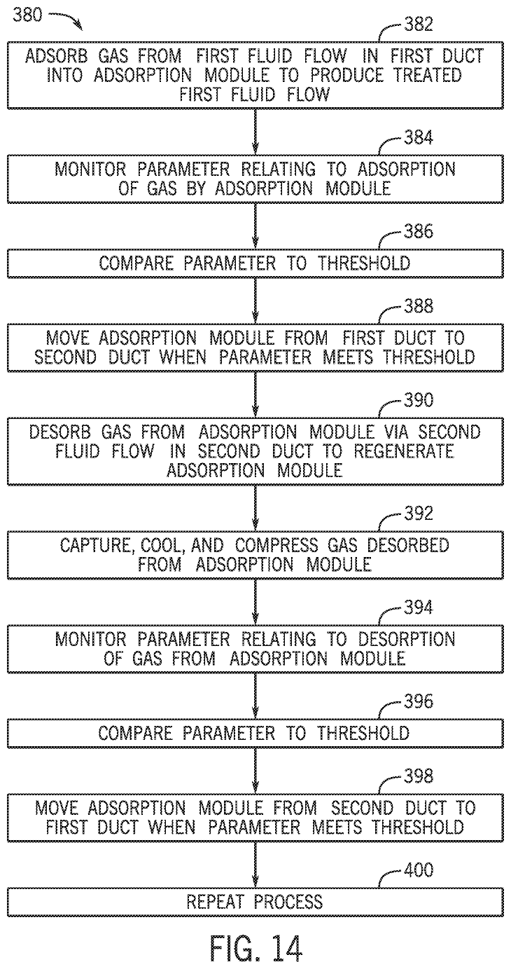

FIG. 14 is flow chart of an embodiment of a process 380 for treating gas in a system, such as the gas treatment system 10 of FIG. 1. The gas treatment may correspond to fuel gas treatment, exhaust gas treatment, or other gas treatments to remove one or more undesirable gases as discussed in detail above. For example, the undesirable gases may include CO₂, H₂S, SO₂, NO₂, or any combination thereof. In the illustrated embodiment, the process 380 may include adsorbing a gas from a first fluid flow 128 in a first duct 102 into an adsorption module 100 to produce a treated first fluid flow 154 as indicated by block 382. The adsorption may include adsorption into one or more sorbent cartridges 210 of the adsorption modules 100 as discussed in detail above. The process 380 may then continue to monitor one or parameters relating to the adsorption of the gas by the adsorption module 100 as indicated by block 384. For example, the process 380 may monitor the various sensors 86 disposed throughout the gas treatment system 16, such as monitoring temperatures, pressures, flow rates, gas compositions of the undesirable gases, rates of change in the adsorption, or any combination thereof. The process 380 may then proceed to compare the parameters to one or more thresholds as indicated by block 386. For example, the process 380 may include comparing an adsorption rate to a threshold adsorption rate. The threshold adsorption rate may indicate that the adsorption module 100 needs to be regenerated to remove the undesirable gases adsorbed into the sorbent material 222 of the sorbent cartridges 210.

The process 380 may then proceed to move the adsorption module 100 from the first duct 102 to the second duct 104 when the parameter meets the threshold as indicated by block 388. Accordingly, the movable adsorption assembly 108 facilitates the movement between the first duct 102 and the second duct 104, such as by moving the adsorption module 100 along the rail assemblies 134 of the linear positioning assembly 132. In particular, the process 380 moves the adsorption module 100 along a linear path of travel defined by the rail assemblies 134, such as perpendicular to longitudinal axes of the ducts 102 and 104.

The process 380 may then proceed to desorb the gas from the adsorption module 100 via a second fluid flow 130 in the second duct 104 to regenerate the adsorption module 100 as indicated by block 390. As discussed above, the regeneration in the second duct 104 may include flowing a heated fluid, such as steam, through and or around the adsorption module 100 to increase the temperature of the sorbent material 222 and help to desorb the undesirable gas from the sorbent cartridges 210 into the fluid flow 130. The process 380 may then proceed to capture, cool, and compress the gas desorbed from the adsorption module 100 as indicated by block 392. The undesirable gas desorbed from the adsorption module 100 may be captured directly at each respective adsorption module 100, in a subsequent process downstream from the adsorption module 100, or by another technique. The cooling also may facilitate separation of the fluid flow 130 from the desorbed gas, such as by condensing a flow of steam to allow separation of the desorbed gas in the duct 104. Additionally, the captured gas may pass through one or more heat exchangers, compressors, or other treatment systems before being routed into storage or a pipeline.

The process 380 may also monitor one or more parameters relating to desorption of the gas from adsorption module 100 as indicated by block 394. For example, the process 380 may monitor the temperature, flow rate, gas composition, or the rate of desorption of the gas from the adsorption module 100. The process 380 may then compare the one or more parameters to corresponding thresholds as indicated by block 396. The comparison in block 396 may include comparing a rate of desorption to a threshold rate of desorption, such that a sufficiently low rate of desorption may trigger the process 380 to move the adsorption module 100 from the second duct 104 to the first duct 102 when the parameter meets the threshold as indicated by block 398. The process 380 may then repeat the process as indicated by block 400. Accordingly, the process 380 may repeatedly cycle or move the adsorption module 100 back and forth between the duct 102 and the duct 104, thereby enabling adsorption of the undesirable gas into the adsorption module 100 in the duct 102 and desorption of the undesirable gas from the adsorption module 100 in the duct 104.

Technical effects of the disclosed embodiments include a gas treatment system with adsorption modules that move linearly between flow paths in first and second ducts, wherein the adsorption module adsorbs an undesirable gas in the first duct and desorbs the undesirable gas in the second duct. The first and second ducts may be positioned directly adjacent one another and may share an intermediate wall. The adsorption modules may be configured to move linearly alone one or more rail assemblies of a linear positioning system. The first duct may also be described as an adsorption duct, while the second duct may be described as a desorption duct. When multiple adsorption modules are installed in the ducts, a controller may control movement and positioning of the adsorption modules, such that one or more adsorption modules are adsorbing the undesirable gases in the first duct while one or more adsorption modules are desorbing the undesirable gases in the second duct.

The subject matter described in detail above may be defined by one or more clauses, as set forth below.

A system includes a gas treatment system having an adsorption module, wherein the adsorption module includes one or more sorbent cartridges having a sorbent material. The gas treatment system further includes a linear positioning assembly configured to move the adsorption module along a linear path of travel between a first position in a first flow path and a second position in a second flow path. The gas treatment system is configured to adsorb an undesirable gas from a first fluid flow in the first flow path into the sorbent material when the adsorption module is disposed in the first position. The gas treatment system is configured to desorb the undesirable gas from the sorbent material when the adsorption module is disposed in the second position.

The system of any preceding clause, including a combustion system having the first flow path coupled to the gas treatment system.

The system of any preceding clause, wherein the combustion system includes a gas turbine system.

The system of any preceding clause, wherein the undesirable gas includes carbon dioxide (CO2).

The system of any preceding clause, wherein the first flow path includes a fuel flow path or an exhaust flow path.

The system of any preceding clause, wherein the second flow path includes a steam flow path.

The system of any preceding clause, including a vacuum system having one or more vacuum pumps configured to create a pressure differential to help separate the undesirable gas from the sorbent material.

The system of any preceding clause, including an intermediate wall disposed between the first and second flow paths, wherein the intermediate wall includes a seal disposed about an opening, the opening is configured to enable movement of the adsorption module between the first and second positions, and the seal is configured to seal against the adsorption module.

The system of any preceding clause, including a first duct having the first flow path and a second duct having the second flow path, wherein the first and second ducts extend along one another.

The system of any preceding clause, wherein the first duct includes an access panel disposed over an access opening in a sidewall of the first duct, and the adsorption module is accessible through the access opening.

The system of any preceding clause, wherein the adsorption module includes a plurality of the sorbent cartridges, and each of the plurality of sorbent cartridges is removable from a framework of the adsorption module.

The system of any preceding clause, wherein the linear positioning assembly includes a first rail assembly having a first slide disposed in a first rail, the first rail extends between the first and second flow paths, and the first slide is coupled to the adsorption module.

The system of any preceding clause, wherein the linear positioning assembly includes a second rail assembly having a second slide disposed in a second rail, the second rail extends between the first and second flow paths, and the second slide is coupled to the adsorption module.

The system of any preceding clause, wherein the first slide includes a first wheel, and the second slide includes a second wheel.

The system of any preceding clause, wherein the linear positioning assembly includes a drive line coupled to a drive and the adsorption module, and the drive is configured to move the drive line to move the adsorption module between the first and second positions.

| The system of any preceding clause, including a controller coupled to the drive and one or more sensors, wherein the controller is configured to control the drive to move the adsorption module between the first and second positions when feedback from the one or more sensors indicates that adsorption meets an adsorption threshold in the first flow path or desorption meets a desorption threshold in the second flow path.

The system of any preceding clause, wherein the gas treatment system comprises a plurality of adsorption modules and a respective plurality of linear positioning assemblies, the plurality of adsorption modules includes the adsorption module, and the plurality of linear positioning assemblies includes the linear positioning assembly.

A system includes a first duct having a first flow path, a second duct having a second flow path, and a plurality of adsorption modules, wherein each adsorption module of the plurality of adsorption modules includes one or more sorbent cartridges having a sorbent material. The system further includes a plurality of linear positioning assemblies, wherein each linear positioning assembly of the plurality of linear positioning assemblies is configured to independently move one of the plurality of adsorption modules between the first and second ducts.

The system of the preceding clause, wherein each of the plurality of adsorption modules is configured to adsorb an undesirable gas into the sorbent material when disposed in the first duct, wherein each of the plurality of adsorption modules is configured to desorb the undesirable gas from the sorbent material when disposed in the second duct.

A method includes moving, via a linear positioning assembly, an adsorption module of a gas treatment system along a linear path of travel between a first position in a first flow path and a second position in a second flow path, wherein the adsorption module includes one or more sorbent cartridges having a sorbent material. The method further includes adsorbing an undesirable gas into the sorbent material of the adsorption module when the adsorption module is disposed in the first position in the first flow path. The method further includes desorbing the undesirable gas from the sorbent material of the adsorption module when the adsorption module is disposed in the second position in the second flow path.

This written description uses examples to describe the present embodiments, including the best mode, and also to enable any person skilled in the art to practice the presently disclosed embodiments, including making and using any devices or systems and performing any incorporated methods. The patentable scope of the presently disclosed embodiments is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a gas treatment system, comprising:
an adsorption module comprising one or more sorbent cartridges having a sorbent material;
a linear positioning assembly configured to move the adsorption module along a linear path of travel between a first position in a first flow path and a second position m a second flow path, wherein the gas treatment system is configured to adsorb an undesirable gas from a first fluid flow in the first flow path into the sorbent material when the adsorption module is disposed in the first position, wherein the gas treatment system is configured to desorb the undesirable gas from the sorbent material when the adsorption module is disposed m the second position.

2. The system of claim 1, further comprising a combustion system having the first flow path coupled to the gas treatment system.

3. The system of claim 2, wherein the combustion system comprises a gas turbine system.

4. The system of claim 1, wherein the undesirable gas comprises carbon dioxide (CO2).

5. The system of claim 1, wherein the first flow path comprises a fuel flow path or an exhaust flow path.

6. The system of claim 1, wherein the second flow path comprises a steam flow path.

7. The system of claim 1, further comprising a vacuum system having one or more vacuum pumps configured to create a pressure differential to help separate the undesirable gas from the sorbent material.

8. The system of claim 1, further comprising an intermediate wall disposed between the first and second flow paths, wherein the intermediate wall comprises a seal disposed about an opening, the opening is configured to enable movement of the adsorption module between the first and second positions, and the seal is configured to seal against the adsorption module.

9. The system of claim 1, further comprising a first duct having the first flow path and a second duct having the second flow path, wherein the first and second ducts extend along one another.

10. The system of claim 9, wherein the first duct comprises an access panel disposed over an access opening in a sidewall of the first duct, and the adsorption module is accessible through the access opening.

11. The system of claim 1, wherein the adsorption module comprises a plurality of the sorbent cartridges, and each of the plurality of sorbent cartridges is removable from a framework of the adsorption module.

12. The system of claim 1, wherein the linear positioning assembly comprises a first rail assembly having a first slide disposed in a first rail, the first rail extends between the first and second flow paths, and the first slide is coupled to the adsorption module.

13. The system of claim 12, wherein the linear positioning assembly comprises a second rail assembly having a second slide disposed in a second rail, the second rail extends between the first and second flow paths, and the second slide is coupled to the adsorption module.
